(19) United States
(12) Patent Application Publication
(10) Pub. No.: US 2015/0263778 A1
(43) Pub. Date: Sep. 17, 2015

(54) PROTECTING CASE AND ASSEMBLY HAVING THE SAME

(71) Applicant: FOXCONN INTERCONNECT TECHNOLOGY LIMITED, Grand Cayman (KY)

(72) Inventor: XIAO-GANG WU, Kunshan (CN)

(21) Appl. No.: 14/656,042

(22) Filed: Mar. 12, 2015

(30) Foreign Application Priority Data
Mar. 12, 2014 (CN) 201410088607.X

(51) Int. Cl. H04B 1/3888

(52) U.S. Cl. CPC H04B 1/3888

(57) ABSTRACT

A protecting case assembly (100) includes a semi-closed protecting case (1) and a cable (2). The protecting case has a bottom wall (11), a pair of side walls (12), and a receiving groove (10) extending along a lengthwise direction. The receiving groove has a receiving slot (110) at the bottom wall, a receiving aperture (121) at one of the side walls, and a receiving hole (122) at the one side wall. The receiving aperture communicates with the receiving slot and the receiving hole and dent inwardly from the bottom wall. The cable having a first connector (22) received in the receiving hole, a second connector (23) received in the receiving slot, and a cable line (21) connecting the first connector with the second connector and received in the receiving aperture.

### BACKGROUND OF THE INVENTION

1. Field of the Invention

The present invention relates generally to a protecting case assembly, and more particularly to a protecting case assembly having a protecting case and a cable.

2. Description of Related Arts

To prevent damage to appliances (mobile phones, tablets, etc.) in use, a case around the appliance is usually equipped. As the widely spread use of smart phones, a cable line connection is essential to charge battery or transmit data. However, the cable is prone to be lost when it is not in use.

A protecting case assembly having an improved protecting case is desired.

### SUMMARY OF THE INVENTION

Accordingly, an object of the present invention is to provide a protecting case assembly for efficient and convenient use.

To achieve the above object, A protecting case assembly comprising: a semi-closed protecting case having a bottom wall, a pair of side walls, and a receiving groove extending along a lengthwise direction, the receiving groove having a receiving slot at the bottom wall, a receiving aperture at one of the side walls, and a receiving hole at the one side wall, the receiving aperture communicating with the receiving slot and the receiving hole and denting inwardly from the bottom wall; and a cable having a first connector received in the receiving hole, a second connector received in the receiving slot, and a cable line connecting the first connector with the second connector and received in the receiving aperture.

### BRIEF DESCRIPTION OF THE DRAWINGS

FIG. 1 is a perspective, assembled view of a protecting case assembly assembled to the appliance;

FIG. 2 is another perspective, assembled view of the protecting case assembly, taken from another aspect with respect to FIG. 1;

FIG. 3 is a perspective, exploded view of the protecting case assembly with respect to FIG. 2; and

FIG. 4 is another perspective, exploded view of the protecting case assembly, taken from another aspect with respect to FIG. 3.

### DETAILED DESCRIPTION OF THE PREFERRED EMBODIMENT

Reference will now be made in detail to the preferred embodiment of the present invention.

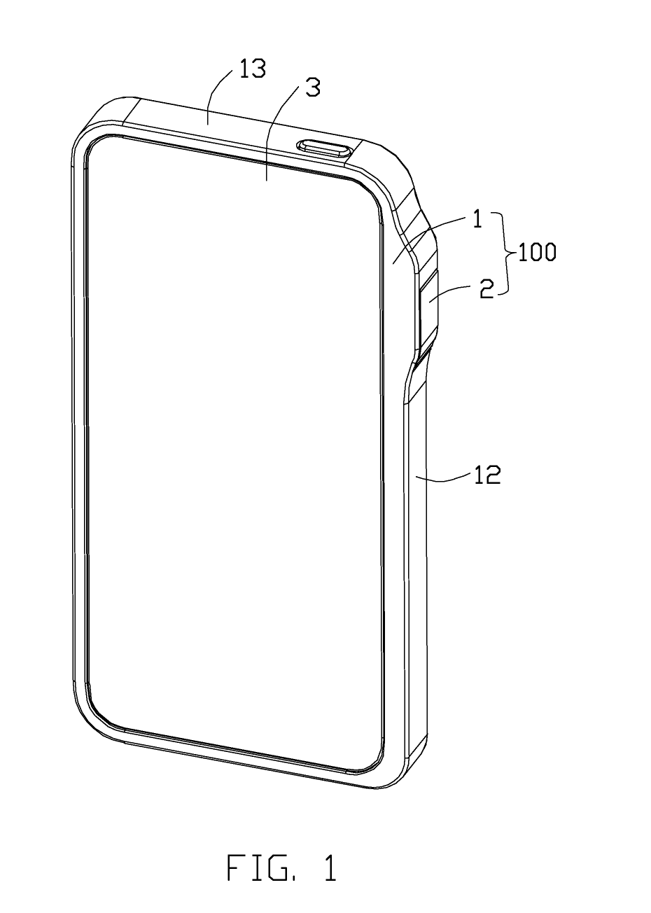

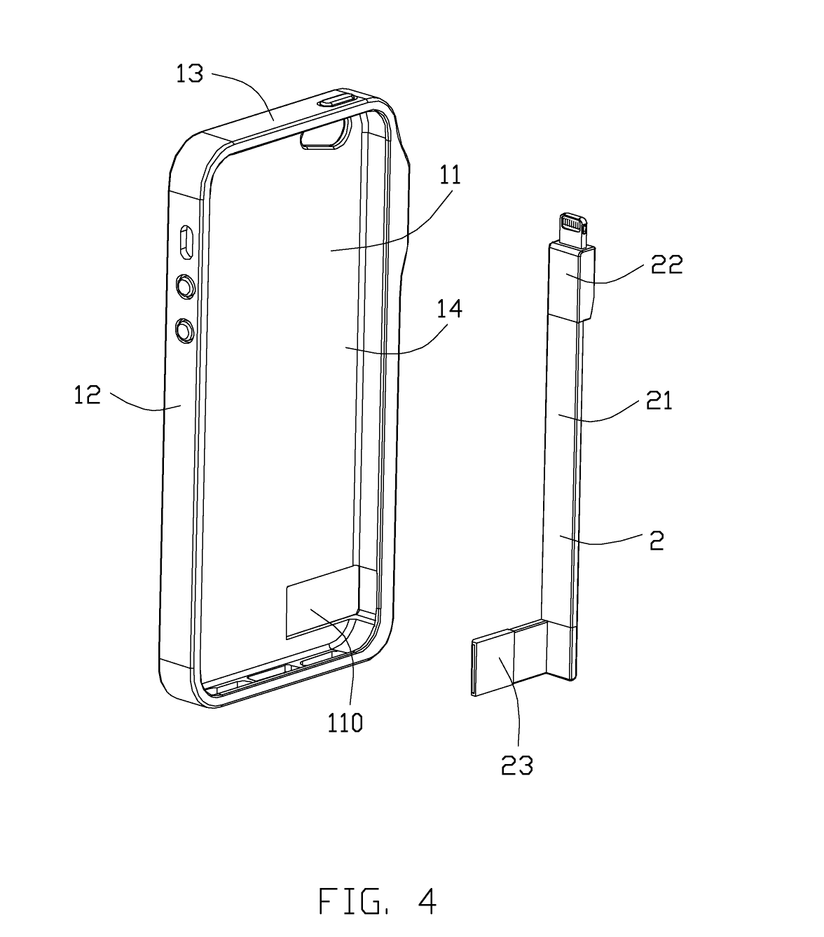

Referring to FIGS. 1 to 4, a protecting case assembly 100 of the present invention includes a protecting case 1 to prevent the appliance 3 from being damaged and a cable 2 assembled in the protecting case 1.

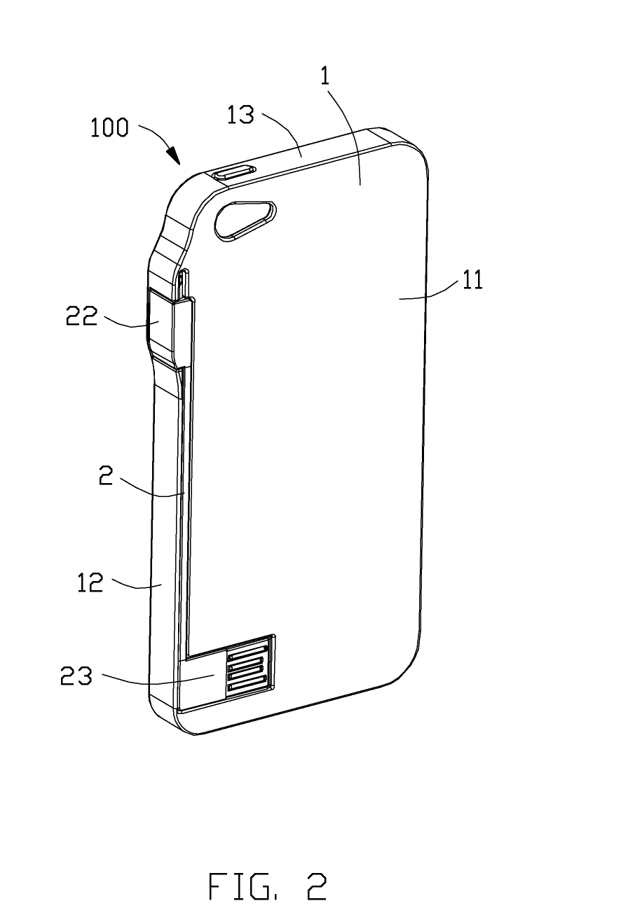

Referring to FIGS. 2 to 4, the protecting case 1 includes a panel-shaped bottom wall 11, a pair of first side walls 12 extending along a length direction from two sides of the bottom wall 11, and a pair of second side walls 13 extending along a width direction from two edges of the bottom wall 11 and defining a receiving cavity 14 therebetween for accommodating the appliance 3. The first side walls 12 are connected with the second walls 13. The protecting case 1 applies to many kinds of appliances like phone, i-pad, tablet and so on.

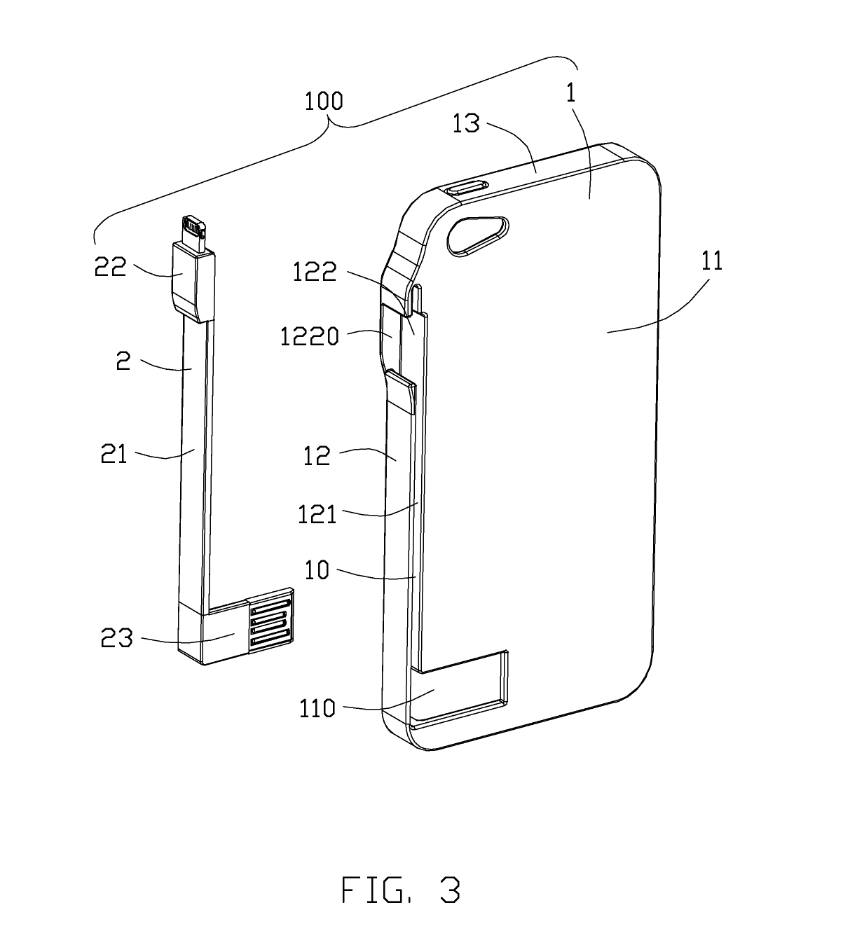

Referring to FIGS. 2 and 3, the protecting case 1 defines a receiving groove 10 to receive the cable 2. The receiving groove 10 includes a receiving slot 110 seated at the bottom wall 11, a receiving hole 122 seated at one of the first side wall 12, and a receiving aperture 121 located at one of the first side wall 12. The receiving aperture 121 dents inwardly from the bottom wall 11. The receiving slot 110 extends through the bottom wall 11 to reduce the thickness of the protecting case 1 and the receiving hole 122 extends through the side wall 12 and formed with an opening 1220. The receiving slot 110, receiving aperture 121, and the receiving hole 122 communicate with each other. In other embodiments, the receiving slot 110 is not necessary to set through the bottom wall 11, or the receiving slot 110 can be defined in the first side walls 12 or the second side walls 13. The receiving hole 122 can be located at the second side walls 13 or bottom wall 11. The receiving aperture 121 can be located at the second side walls 13 or the bottom wall 11.

The cable 2 is formed with a first plug connector 22, a second plug connector 23, and a cable line 21 connected with the first plug connector 22 and the second plug connector 23. The cable line 21 is flat and received in the cable line-received aperture 122. The first plug connector 22 is received in the receiving hole 122 and exposed to the first side wall 12 from the opening 1220 to make it easy to get the cable 2. The second plug connector 23 is received in the receiving slot 110 and exposed to the bottom wall 11.

In this embodiment, the cable line 21 of the cable 2 is defined to be flat so that the cable line 21 is not excessively exposed to exterior when the cable line 21 is received in the receiving aperture 121. The receiving aperture 121 is also possible to be located in the bottom wall 11 to avoid affecting the button and jack.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A protecting case assembly comprising:
a semi-closed protecting case having a bottom wall, a pair of side walls, and a receiving groove extending along a lengthwise direction, the receiving groove having a receiving slot at the bottom wall, a receiving aperture at one of the side walls, and a receiving hole at the one side wall, the receiving aperture communicating with the receiving slot and the receiving hole and denting inwardly from the bottom wall; and
a cable having a first connector received in the receiving hole, a second connector received in the receiving slot, and a cable line connecting the first connector with the second connector and received in the receiving aperture.

2. The protecting case assembly as claimed in claim 1, wherein the receiving slot extends through the bottom wall.

3. The protecting case assembly as claimed in claim 1, wherein the second connector is substantially flush with an outer surface of the bottom wall.

4. The protecting case assembly as claimed in claim 1, wherein the receiving hole extends through the first side wall.

5. The protecting case assembly as claimed in claim 1, wherein the first connector is substantially flush with an outer surface of the one side wall.

6. A protecting case assembly for use with a mobile phone, comprising:
a bottom wall and a circumferential side wall unitarily extending upwardly from a periphery of said bottom wall;
a receiving slot formed in a portion of said side wall and open to an exterior downwardly; and
a cable assembly including first and second connector at two opposite ends and detachable received within said receiving slot.

7. The protecting case assembly as claimed in claim 6, wherein the side wall forms an lateral expanded region to receive the first connector.

8. The protecting case assembly as claimed in claim 7, wherein a width of said first connector is not larger than a height of said side wall.

9. The protecting case assembly as claimed in claim 7, wherein a thickness of the first connector is larger than that of the bottom wall.

10. The protecting case assembly as claimed in claim 7, wherein said lateral expanded region forms an opening for easing removal of the first connector from the receiving slot.

11. The protecting case assembly as claimed in claim 6, wherein the bottom wall forms a recess to receive the second connector.

12. The protecting case assembly as claimed in claim 11, wherein a width of said second connector is larger than a height of the side wall.

13. The protecting case assembly as claimed in claim 11, where a thickness of the second connector is not larger than that of the bottom wall.

14. The protecting case assembly as claimed in claim 6, where the side wall forms an opening configured to comply with a contour of one of the first connector and the second connector.

15. The protecting case assembly as claimed in claim 6, wherein said cable assembly extends in an L-shaped configuration.
